(19) United States
(12) Patent Application Publication
(10) Pub. No.: US 2001/0027173 A1
(43) Pub. Date: Oct. 4, 2001

(54) Fabric softening compounds and compositions

(76) Inventors: James Patrick Conroy, Wirral (GB); Craig Warren Jones, Wirral (GB)

Correspondence Address: UNILEVER, PATENT DEPARTMENT, 45 RIVER ROAD, EDGEWATER, NJ, 07020, US

(21) Appl. No.: 09/737,654

(22) Filed: Dec. 15, 2000

(30) Foreign Application Priority Data
Dec. 20, 1999 (GB) 9930105.3

(51) Int. Cl. C11D 3/00; D06L 1/04

(52) U.S. Cl. 510/287

(57) ABSTRACT

A softening compound comprises a derivative of a cyclic polyol or a derivative of a reduced saccharide having, on average, 30 to 80% of its hydroxyl groups esterified and/or etherified, one or more long chain C₈ to C₂₂ alkyl, alkenyl or hydroxyalkyl groups and one or more quaternary ammonium group, the C₈ to C₂₂ alkyl, alkenyl or hydroxyalkyl group(s) being attached to an ester or ether group. Preferably the compound has two or more ester and/or ether groups. A fabric softening composition comprises from 1 to 80 wt % of the softening compound, based on the total weight of the composition. A method for forming such compounds comprises reacting a cyclic polyol or a reduced saccharide with a fatty acid and a halogen alkyl acid chloride to form an, at least partly, esterified cyclic polyol or reduced saccharide and then quaternising the esterified compound so as to form a CPED or RSED comprising a quaternary ammonium group.

### FIELD OF THE INVENTION

The present invention relates to compounds capable of softening fabrics; fabric softening compositions comprising such compounds and methods for forming such compounds.

### BACKGROUND OF THE INVENTION

Rinse added fabric conditioning compositions are well known. Typically, such compositions comprise a fabric softening agent dispersed in water. The fabric softening agent can be included at up to 8% by weight, in which case the compositions are considered dilute, or at levels from 8% to 60% by weight, in which case the compositions are considered concentrated.

Typically the fabric softening agent is a cationic quaternary ammonium compound having one to three ester links.

Conventional cationic compounds deposit onto fabric due to their charge, but they can render fabrics hydrophobic and thus less water absorbent.

However, absorbency of fabrics is desired by consumers, especially for products dependent upon absorbency for their proper functioning, such as towels and dish cloths.

Therefore, it is desirable to provide a softening compound which does not render fabrics hydrophobic.

It is known to provide softening compounds, such as nonionic surfactants. These do not render fabrics as hydrophobic as cationic softening compounds.

For instance, U.S. Pat. No. 5,447,643 (Huls) relates to aqueous fabric softeners comprising nonionic surfactants and mono-, di- or tri-fatty acid esters of polyols.

WO 91/10719 (Novo) relates to bleaching detergent compositions comprising derivatives of pentoses and hexoses having long chain alkyl groups attached thereto through a glycosidic bond.

WO 98/16538 (Unilever) relates to fabric treatment compositions comprising cyclic polyols or reduced saccharides which are at least partly esterifed.

EP 380406 (Colgate Palmolive) discloses detergent compositions comprising a saccharide or reduced saccharide ester containing at least one fatty acid chain.

However, as nonionic softening compounds are not charged, they do not deposit as well as cationic fabric softening compounds onto fabric. Thus, a deposition aid, such as a cationic compound, is required in order to assist the nonionic fabric softening compound to deposit onto the fabric.

For instance, WO 95/00614 (Kao) teaches that softening compounds such as polyhydric alcohol esters can be deposited more effectively if a cationised cellulose is present.

GB 1601359 (Procter and Gamble) discloses textile treatment compositions containing mixtures of cationic and nonionic surfactants.

WO 96/15213 (Henkel) discloses sugar derivatives comprising alkyl, alkenyl and/or acyl groups in combination with nonionic and cationic emulsifers and depositions aids.

The provision of an additional cationic compound to compositions containing nonionic surfactants is undesirable as it increases the cost of raw materials, as well as the processing time and cost. Also, by incorporating further compounds into the composition, this may be detrimental to the environment.

Other fabric softening compounds are known. For example, WO 99/36167 (Matsumoto Yushi Seiyaku) discloses cationic surfactants derived from amine derivatives of hexose alcohols, which are reducing sugars of glucose or hexose.

It is desirable to provide compounds which are capable of softening effectively and which deposit onto fabric by themselves but do not substantially reduce the absorbency of the softened fabric, once deposited thereon.

It is also desirable to provide softening compositions which are capable of depositing perfume onto the fabric so that consumers can perceive a sufficient perfume intensity from the fabric.

Other properties which are desirable in fabric softening compositions include stability of the softening composition upon storage and good dispersibility of the softening compositions in water.

### OBJECTS OF THE INVENTION

The present invention seeks to address one or more of the above-mentioned problems, and to give one or more of the above-mentioned benefits desired by consumers.

We have now found that a novel range of compounds containing an esterified or etherified sugar group in combination with a quaternary ammonium group deposit onto fabric without requiring a deposition aid, unlike conventional nonionic softening compounds, and yet do not reduce the absorbency of the treated fabric as much as conventional cationic softening compounds.

### SUMMARY OF THE INVENTION

According to the present invention there is provided a compound comprising a derivative of a cyclic polyol (“CPED”) or a derivative of a reduced saccharide (“RSED”) having, on average, 30 to 80% of its hydroxyl groups esterified and/or etherified, the compound having one or more long chain C₈ to C₂₂ alkyl, alkenyl or hydroxyalkyl groups and one or more quaternary ammonium groups, the C₈ to C₂₂ alkyl, alkenyl or hydroxyalkyl group(s) being attached to an ester or ether group.

According to the invention, there is also provided a fabric softening composition comprising a compound as defined above.

According to the invention there is also provided a method for forming a CPED or RSED comprising reacting a cyclic polyol or a reduced saccharide with a fatty acid and a halogen alkyl acid chloride to form an, at least partly, esterified and/or etherified cyclic polyol or reduced saccharide and then quaternising the, at least partly esterified and/or etherified, compound so as to form a CPED or RSED comprising a quaternary ammonium group.

### DETAILED DESCRIPTION OF THE INVENTION

A. Softening Compounds

The compounds of the present invention comprise a derivative of a cyclic polyol (“CPED”) or a derivative of a reduced saccharide (“RSED”).

The CPED or RSED comprises one or more long chain C₈ to C₂₂ alkyl, alkenyl or hydroxyalkyl groups.

If the compound is a CPED, it is preferred that it has 6 or less, more preferably 5 or less, even more preferably 4 or less long chain C₈ to C₂₂ alkyl, alkenyl or hydroxyalkyl groups.

If the compound is a RSED, it is preferred that it has 3 or less, more preferably 2 or less long chain C₈ to C₂₂ alkyl, alkenyl or hydroxyalkyl groups.

The C₈ to C₂₂ alkyl, alkenyl or hydroxyalkyl groups may comprise branched or linear carbon chains.

Preferably the carbon chains in the CPED or RSED are at least partially unsaturated.

If the oily sugar derivative comprises hydrocarbyl chains formed from fatty acids or fatty acyl compounds which are unsaturated or at least partially unsaturated (e.g. having an iodine value of from 5 to 140, preferably 5 to 100, more preferably 5 to 60, most preferably 5 to 40, e.g. 5 to 25), then the cis:trans isomer weight ratio in the fatty acid/fatty acyl compound is greater than 20/80, preferably greater than 30/70, more preferably greater than 40/60, most preferably greater than 50/50, e.g. 70/30 or greater. It is believed that higher cis:trans isomer weight ratios afford the compositions comprising the compound better low temperature stability and minimal odour formation.

Saturated and unsaturated fatty acids/acyl compounds may be mixed together in varying amounts to provide a compound having the desired iodine value.

Fatty acids/acyl compounds may also be, at least partially hydrogenated to achieve lower iodine values.

Of course, the cis:trans isomer weight ratios can be controlled during hydrogenation by methods known in the art such as by optimal mixing, using specific catalysts and providing high H₂ availability.

Preferred levels of unsaturation are when the iodine value (IV) of the parent fatty acid or parent fatty acyl compound from which the long carbon chain is formed is from about 40 to about 140, more preferably from about 45 to 80.

For a method of calculating iodine values of fatty acids and fatty acyl compounds, see co-pending application PCT/EP00/0564.

It is preferred that the compounds comprise long carbon chains of mixed length, as this increases the likelihood of the compounds forming an oil (which, it is believed, renders fabrics less hydrophobic when the compounds are deposited thereon). Alternatively, the compounds may comprise carbon chains of a single length.

Each long chain C₈ to C₂₂ alkyl, alkenyl or hydroxyalkyl group is attached to an ester or ether group.

The CPED or RSED has, on average, 30 to 80% of its hydroxyl groups esterified or etherified. More preferably 35% to 75%, most preferably 40% to 70% of the hydroxyl groups are, on average, esterified or etherified.

Thus, the CPED preferably has, on average, 2 or more, more preferably 4 or more, of the hydroxyl groups esterified and/or etherified.

The RSED preferably has, on average, 2 or more, more preferably 3 or more, hydroxyl groups esterified and/or etherified.

The compounds exist as a mixture of materials ranging from the mono-ester or ether to the fully esterified/etherified.

Thus, the phrase “on average” means that, in a sample of the CPED or RSED where the molecules may have a range of degrees of esterification and/or etherification, the level of esterification and/or etherification (represented by either the number of hydroxyl groups esterified and/or etherified or by the percentage of the overall number of hydroxyl groups present in the compound which are esterified and/or etherified)is the average degree of esterification/etherification as determined by weight.

The CPED or RSED has at least one quaternary ammonium group. Preferably the quaternary ammonium group is attached to the CPED or RSED via a short chain C₂ to C₈ alkyl, alkenyl or hydroxyalkyl group.

Any compatible counterion may be used in the compounds. Preferred counterions are water-soluble and include halides and alkylsulphates. However, other suitable counterions known to those skilled can be used.

Examples of preferred cyclic polyols from which CPEDs can be derived include Inositol and all forms of saccharides.

Examples of preferred saccharides are monosaccharides and disaccharides.

Examples of monosaccharides include xylose, arabinose, galactose, fructose, sorbose and glucose. Examples of disaccharides include maltose, lactose, cellobiose and sucrose.

An example of a reduced saccharide from which RSEDs can be derived is sorbitan.

Most preferably, the CPED or RSED is based on sucrose or sorbitan respectively.

Especially preferred formulae are as follows.

Where the compound is a CPED, the preferred formula is:

(C₁₂O₃H₁₄)(OH)₈₋ₐ(OC(O)R¹N(R²)₃X)_{b}(OC(O)R³)_{c}

where

R¹ is C₂₋₈ alkyl, alkenyl or hydroxyalkyl

R² is C₁₋₄ alkyl or hydroxyalkyl or C₂₋₄ alkenyl

R³ is C₈₋₂₂ alkyl, alkenyl or hydroxyalkyl

X is a water soluble anion

b=1 or more and preferably 2 or less

b+c is no more than 7

a=b+c.

A mixture of compounds corresponding to the above formula may be present. Thus a, b and c may or may not be integers.

Where the compound is a RSED, the preferred formula is:

(C₆H₈O)(OH)₄₋ₐ(OC(O)R¹N(R²)₃X)_{b}(OC(O)R³)_{c}

where

R¹, R², R³ and X are as defined above and

b=1 or more and preferably less than 2

b+c is no more than 3 and

a=b+c

A mixture of compounds corresponding to the above formula may be present. Thus a, b and c may or may not be integers.

Structure of the Compound

The compounds preferably have the following general structures:

(i) where the compound is a CPED, the structure can be:

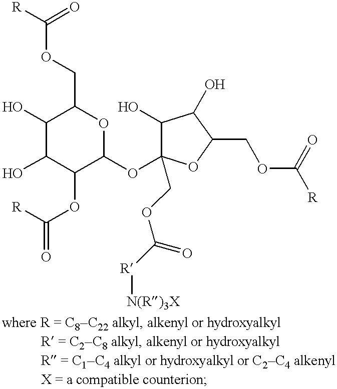

(ii) where the compound is a RSED, the structure can be:

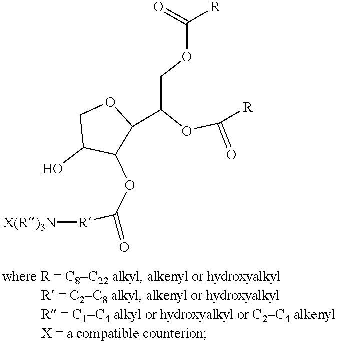

Compound Form

At room temperature, the compound is preferably a liquid, more preferably a viscous liquid or a soft solid. Preferably the compound does not have any substantial crystalline character at room temperature.

Liquid or soft-solid CPED's and RSED's are characterised as materials having a solid:liquid ratio of between 50:50 and 0:100 more preferably between 43:57 and 0:100, e.g. 30:70 and 0:100 as determined by T₂ relaxation time N.M.R. T₂ N.M.R. relaxation time is commonly used for characterising solid:liquid ratios in soft solid products such as fats and margarines. For the purposes of the present invention, any component of the N.M.R. signal with a T₂ of less than or more than 100 microseconds is considered to be a solid component or liquid component respectively.

Preparation of the Compounds

The compound may be prepared according to any suitable method.

Method 1

In a first method, compounds of the invention are prepared as follows:

(i) The cyclic polyol or reduced saccharide is firstly reacted with a fatty acid chloride.

Any suitable fatty acid groups may be used, though the chain length of the fatty acid group is preferably within the range of about C₈ to about C₂₂. Typical fatty acid chlorides include oleyl chloride, erucyl chloride, and octyl chloride. Of these, oleyl chloride is the most preferred.

(ii) The product of step (i) is then esterified by reaction with a halogen alkyl acid chloride to form an esterified polyol or esterified reduced saccharide.

Any suitable halogen alkyl acid chloride may be used. It is preferred that the alkyl chain length is within the range from about C₂ to about C₈.

Especially preferred halogen alkyl acid chlorides include 4-bromobutyryl chloride, 3-chloropropyl chloride and 5-bromopentyl chloride.

Alternative esterification reactions include acylation of the polyol/reduced saccharide with an acid chloride; trans-esterification of the polyol/reduced saccharide with a catalyst (suitable catalysts include lead oxide, alkyl tin chloride, titanium(IV) chloride, sulphuric acid, toluene sulphonic acid, alkali metal hydroxides, lipase or alkali cyanides); acylation of the polyol/reduced saccharide with an-alkyl or alkenyl carboxylic acid.

Other esterification reactions are described in U.S. Pat. No. 4286213 (Procter & Gamble) and AU 14416/88 (Procter & Gamble), the contents of which are incorporated herein.

(iii) The esterified polyol or esterified reduced saccharide produced in step (ii) is then quaternised.

Various reactions known to those skilled in the art may be used in the quaternisation reaction. For instance, the polyol or reduced saccharide may be quaternised using a tertiary amine.

Method 2

In a second method, step (i) and step (ii), above, are carried out simultaneously, followed by step (iii).

Method 3

In a third method, compounds of the invention are prepared from non-quaternised sugar ester compounds.

Examples of cyclic polyol esters include sucrose octaoleate,. esters of alkyl(poly)glucosides, in particular alkyl glucoside esters having a degree of polymerisation from 1 to 2.

Commercially available cyclic polyol ester compounds include sucrose laurate, available as Ryoto LWA-1570 (RTM); sucrose oleate, available as Ryoto O-170 (RTM) or Ryoto OWA-1570; sucrose eruceate, available as Ryoto ER-190 (RTM) or Ryoto ER-290 (RTM), all ex Mitsubishi Kagaku Food Corp.

Examples of reduced saccharide esters include fatty acid esters of glucose, the ester groups comprising C₂-C₁₈ alkyl or alkenyl chain and the degree of esterification being 5 and in particular saccharides having ester groups consisting essentially of a C₂ alkyl chain and a C₈ to C₁₂ straight alkyl chain, the molar ratio of short chain C₂ alkyl chains to C₈ to C₁₂ straight alkyl chains being from 2:1 to 1:2, more preferably about 1:1.

The sugar ester compounds can be quaternised using a tertiary amine.

### EXAMPLES

The preparation of the compounds will now be illustrated by the following non-limiting examples. Further modifications within the scope of the present invention will be apparent to the person skilled in the art.

Compounds of the invention are denoted by a number whilst comparative compounds are denoted by a letter.

Compound 1

Sucrose 11.4 g (0.03 mol) was fully dissolved in pyridine (300 ml) at 110° C. The solution was then cooled to room temperature, and transferred to a 3 necked round bottom flask, fitted with an oil bath, condenser, thermocouple, magnetic stirrer and dropping funnel. A trace of dimethylamino pyridine was added as an esterification catalyst. 4-Bromobutyryl chloride (5.6 g, 0.03 mol) and oleyl chloride (31.8 g, 0.105 mol) were dissolved in chloroform (100 ml) and charged to the dropping funnel. The acid chloride mixture was added to the pyridine-solution over a period of 2 hours whilst the temperature was maintained below 35° C.

After addition of the acid chloride mixture (4-bromobutyryl chloride and oleyl chloride), the pyridine solution was stirred for 20 hours. The solution was then decanted into a Buchi flask and the excess pyridine and chloroform were removed under reduced pressure at 60° C. This produced pyridine hydrogen chloride salt and a thick oil.

Diethyl ether (150 ml) and hydrogen chloride solution (100 ml, 0.05 mol) were added and the contents transferred to a separating funnel. The aqueous layer was discarded and the organic layer washed with brine until it was pH neutral. The organic layer was then dried over magnesium sulphate for 3 hours. The magnesium sulphate was then filtered off, and the organic layer placed in a Buchi flask. The ether was removed at 60° C. under reduced pressure, leaving a thick golden brown coloured oil.

The golden brown oil was analyzed by ¹H NMR in order to ascertain its esterified OH group content. 0.1 g of product was dissolved in 2 ml of CDCl₃ together with a small amount of trichloroacetyl isocyanate (TCAI) to derivatize the free OH groups to urethane linkages. The integration at 8-10 ppm (the derivatized OH's with TCAI) was compared to the integration at 4-6 (the ester links). This showed that the oil had an average degree of esterification of 3.8.

The golden brown oil (30 g) was then dissolved in ethyl acetate and contacted with trimethylamine (30 g of a 33% m/m solution in ethanol). The solution was refluxed for 6 hours, a further aliquat of trimethylamine (30 g) was added and the reflux was continued for another 6 hours. During reflux, the solution turned cloudy. After the second reflux, the solvents and residual trimethylamine were removed under reduced pressure, at 50° C. for 3 hours. This produced a thick, nearly immobile oil (at room temperature).

The thick oil was analyzed by H NMR and shown to contain a N(CH₃)₃ peak at 2.8 ppm relative to tetramethylsilane (TMS). This was indicative of a trimethyl ammonium function.

This product is referred to as Compound 1.

Compound 2

Sucrose 7.87 g (0.023 mol) was fully dissolved in pyridine (200 ml) at 110° C. The solution was then cooled to room temperature, and transferred to a 3 necked round bottom flask, fitted with an oil bath, condenser, thermocouple, magnetic stirrer and dropping funnel.

A trace of dimethylamino pyridine was added as an esterification catalyst. 4-Bromobutyryl chloride (3.52 g, 0.019 mol) and erucyl chloride (35 g, 0.098 mol) were dissolved in chloroform (50 ml) and charged to the dropping funnel. The acid chloride mixture was added to the pyridine solution over a 2 hour period whilst the temperature was maintained below 35° C.

After addition of the chloride mixture, the pyridine solution was stirred for 20 hours. The solution was then decanted into a Buchi flask and the excess pyridine and chloroform removed under reduced pressure at 60° C. A thick oil and the pyridine hydrogen chloride salt remained.

Diethyl ether (150 ml) and hydrogen chloride solution (100 ml, 0.05 mol) were added and the contents transferred to a separating funnel. The aqueous layer was discarded and the organic layer washed with brine until it was pH neutral. The organic layer was then dried over magnesium sulphate for 3 hours. The magnesium sulphate was then filtered off, and the organic layer placed in a Buchi flask. The ether was removed at 60° C. under reduced pressure, leaving a thick golden brown coloured oil.

The golden brown material was analyzed by ¹H NMR using the same method as set out for compound 1. This showed that the oil had an average degree of esterification of 4.5.

The oil (30 g) was then dissolved in ethyl acetate and contacted with trimethylamine (30 g of a 33% m/m solution in ethanol). The solution was then refluxed for 6 hours, a further aliquat of trimethylamine (30 g) was added and the reflux was continued for another 6 hours. During reflux, the solution turned cloudy. After the second reflux the solvents and residual trimethylamine were removed under reduced pressure and at 50° C. for 3 hours.

A thick, nearly immobile oil at room temperature was produced. This was analysed by ¹H NMR and was shown to contain a N(CH₃)₃ peak at 2.9 ppm relative to tetramethylsilane (TMS) indicative of a trimethyl ammonium function.

This product is referred to as Compound 2.

Compound 3

Sucrose 15 g (0.0438 mol) was fully dissolved in pyridine (300 ml) at 110° C. The pyridine solution was then cooled to room temperature, and transferred to a 3 necked round bottom flask, fitted with an oil bath, condenser, thermocouple, magnetic stirrer and dropping funnel.

A trace of dimethylamino pyridine was added as an esterification catalyst. 4-Bromobutyryl chloride (8.12 g, 0.0438 mol) and oleyl chloride (52.7 g, 0.175 mol) dissolved in chloroform (100 ml) and charged to the dropping funnel. The acid chloride mixture was added to the pyridine solution over a period of 2 hours whilst the temperature was maintained below 35° C.

After addition of the chloride mixture the pyridine solution was stirred for 20 hours. The pyridine solution was then decanted into a Buchi flask and the excess pyridine and chloroform removed under reduced pressure. A thick oil and the pyridine hydrogen chloride salt remained.

Diethyl ether (150 ml) and hydrogen chloride solution (100 ml, 0.05 mol) were added and the contents transferred to a separating funnel. The aqueous layer was discarded and the organic layer washed with brine until it was pH neutral. The organic layer was then dried over magnesium sulphate for 3 hours. The magnesium sulphate was then filtered off, and the organic layer placed in a Buchi flask.

The ether was removed at 60° C. under reduced pressure, leaving a thick golden brown coloured oil.

The golden brown oil was analyzed by ¹H NMR using the same method as set out for compound 1. This showed that the material had an average degree of esterification of 4.3.

The oil (30 g) was then dissolved in ethyl acetate and contacted with trimethylamine (30 g of a 33% m/m solution in ethanol). The solution was then refluxed for 6 hours, a further aliquat of trimethylamine (30 g) was added and the reflux was continued for another 6 hours. During reflux, the solution turned cloudy. After the second reflux the solvents and residual trimethylamine were removed under reduced pressure and at 50° C. for 3 hours.

A thick nearly immobile oil at room temperature was afforded, which when analyzed by H NMR contained a N(CH₃)₃ peak at 2.8 ppm relative to tetramethylsilane (TMS) indicative of a trimethyl ammonium function.

This product is referred to as Compound 3.

Compound 4

Sucrose 11.8 g (0.035 mol) was fully dissolved in pyridine (300 ml) at 110° C. The pyridine solution was then cooled to room temperature, and transferred to a 3 necked round bottom flask, fitted with an oil bath, condenser, thermocouple, magnetic stirrer and dropping funnel.

A trace of dimethylamino pyridine was added as an esterification catalyst. 4-Bromobutyryl chloride (6.49 g, 0.035 mol) and oleyl chloride (52.7 g, 0.175 mol) were dissolved in chloroform (100 ml) and charged to the dropping funnel. The acid chloride mixture was added to the pyridine solution over a period of 2 hours whilst the temperature was maintained below 35° C.

After addition of the chloride mixtures the pyridine solution was stirred for 20 hours. The pyridine solution was then decanted into a Buchi flask and the excess pyridine and chloroform removed under reduced pressure at 60° C. A thick oil and the pyridine hydrogen chloride salt remained.

Diethyl ether (150 ml) and hydrogen chloride solution (100 ml, 0.05 mol) were added and the contents transferred to a separating funnel. The aqueous layer was discarded and the organic layer washed with brine until it was pH neutral. The organic layer was then dried over magnesium sulphate for 3 hours. The magnesium sulphate was then filtered off, and the organic layer placed in a Buchi flask. The ether was removed at 60° C. under reduced pressure, leaving a thick golden brown coloured oil.

The oil was analyzed by ¹H NMR using the same method as set out for compound 1. This showed that the oil had an average degree of esterification of 4.7.

The esterified oil (30 g) was then dissolved in ethyl acetate and contacted with trimethylamine (30 g of a 33% m/m solution in ethanol). The solution was then refluxed for 6 hours, a further aliquat of trimethylamine (30 g) was added and the reflux was continued for another 6 hours. During reflux, the solution turned cloudy. After the second reflux, the solvents and residual trimethylamine were removed under reduced pressure and at 50° C. for 3 hours.

A thick nearly immobile oil at room temperature was afforded, which when analyzed by H NMR contained a N(CH₃)₃ peak at 2.8 ppm relative to tetramethylsilane (TMS) indicative of a trimethyl ammonium function.

This product is referred to as Compound 4.

Compound 5

Sucrose 16.77 g (0.049 mol) was fully dissolved in pyridine (300 ml) at 110° C. The pyridine solution was then cooled to room temperature, and transferred to a 3 necked round bottom flask, fitted with an oil bath, condenser, thermocouple, magnetic stirrer and dropping funnel.

A trace of dimethylamino pyridine was added as an esterification catalyst. 4-Bromobutyryl chloride (11.87 g, 0.064 mol) and oleyl chloride (47.8 g, 0.159 mol) were dissolved in chloroform (100 ml) and charged to the dropping funnel. The acid chloride mixture was added to the pyridine solution over 2 hours whilst the temperature was maintained below 35° C.

After addition of the chloride mixture, the pyridine solution was stirred for 20 hours. The solution was then decanted into a Buchi flask and the excess pyridine and chloroform removed under reduced pressure at 60° C. A thick oil and the pyridine hydrogen chloride salt remained.

Diethyl ether (150 ml) and hydrogen chloride solution (100 ml, 0.05 mol) were added and the contents transferred to a separating funnel. The aqueous layer was discarded and the organic layer washed with brine until it was pH neutral. The organic layer was then dried over magnesium sulphate for 3 hours. The magnesium sulphate was then filtered off, and the organic layer placed in a Buchi flask. The ether was then removed at 60° C. under reduced pressure, to afford a thick golden brown coloured oil.

The material was analyzed by ¹H NMR using the method as for compound 1. This showed that the material had an average degree of esterification of 3.8.

The esterified oil (30 g) was then dissolved in ethyl acetate and contacted with trimethylamine (30 g of a 33% m/m solution in ethanol). The solution was refluxed for 6 hours, a further aliquat of trimethylamine (30 g) was added and the reflux was continued for a further 6 hours. During reflux, the solution turned cloudy.

After the second reflux the solvents and residual trimethylamine were removed under reduced pressure at 50° C. for 3 hours. This left a thick, nearly immobile oil at room temperature, which when analyzed by ¹H NMR contained a N(CH₃)₃ peak at 2.8 ppm relative to tetramethylsilane (TMS) indicative of a trimethyl ammonium function.

This product is referred to as Compound 5.

Compound N

Sucrose 11.4 g (0.03 mol) was fully dissolved in pyridine (300 ml) at 110° C. The pyridine solution was then cooled to room temperature, and transferred to a 3 necked round bottom flask, fitted with an oil bath, condenser, thermocouple, magnetic stirrer and dropping funnel.

A trace of dimethylamino pyridine, was added as an esterification catalyst. Oleyl chloride (36 g, 0.12 mol) was dissolved in chloroform (100 ml) and charged to the dropping funnel. The oleyl chloride was added to the pyridine solution over a period of 2 hours whilst the temperature was maintained below 35° C.

After addition of the oleyl chlorides, the pyridine solution was stirred for 20 hours. The solution was then decanted into a Buchi flask and the excess pyridine and chloroform removed under reduced pressure. A thick oil and the pyridine hydrogen chloride salt remained.

Diethyl ether (150 ml) and hydrogen chloride solution (100 ml, 0.05 mol) were added and the contents transferred to a separating funnel. The aqueous layer was discarded and the organic layer washed with brine until it was pH neutral. The organic layer was then dried over magnesium sulphate for 3 hours. The magnesium sulphate was then filtered off, and the organic layer placed in a Buchi flask. The ether was removed at 60° C. under reduced pressure, leaving a thick golden brown coloured oil.

The golden brown material was analyzed by ¹H NMR using the method as for compound 1. This showed that the material had an average degree of esterification of 3.8.

The product formed was an unquaternised sucrose ester.

This product is referred to as Compound N.

An elemental analysis of compounds 1 to 5 was carried out using a Perkin Elmer BLM OG Analyser (series PE 2400).

For each compound, two measurements were taken and the results averaged.

In the following table, the measured and theoretical values of carbon, hydrogen and nitrogen content of compounds 1 to 5 are given. Values within brackets represent the theoretical amounts.

TABLE 1

| | Element | | |
|---|---|---|---|
| Compound | carbon | hydrogen | nitrogen |
| 1 | 66.50 (65.32) | 9.87 (9.84) | 0.64 (1.04) |
| 2 | 70.94 (72.00) | 10.78 (10.90) | 0.32 (0.65) |
| 3 | 69.13 (69.40) | 10.31 (10.68) | 0.49 (0.76) |
| 4 | 67.48 (67.26) | 10.07 (10.44) | 0.84 (0.89) |
| 5 | 66.09 (65.80) | 9.84 (10.50) | 0.75 (1.39) |

All values denote % of the compound comprising the element.

B. Fabric Softening Compositions

The present invention also relates fabric softening compositions comprising the aforementioned novel compounds.

Preferably the softening compound is present in the composition at a level of 1-80%, more preferably 3-50%, most preferably 5-30% by weight based on the total weight of the composition.

Optional Ingredients in Softening Compositions

The compositions may contain other ingredients conventionally present in softening compositions.

1. Viscosity Modifier

When the composition is in a liquid form, it is advantageous to add a viscosity modifier.

Preferred viscosity modifiers include biological polymers, synthetic viscosity modifiers, decoupling polymers and deflocculating polymers.

Biological polymers include: xanthum gum (commercially available as Kelco (RTM), ex Kelsan, or Rhodopol (RTM), ex Rhone Poulenc); guar gum (commercially available as Jaguar (RTM), ex Rhone Poulenc); starches and cellulose ethers.

Synthetic viscosity modifiers include polyacrylic acid, polyvinyl pyrrolidone, polyethylene carbomers, polyethylene glycols and cross-linked polyacrylamides.

Deflocculating polymers include napthalenesulphonic acid polymers with formaldehyde sodium salt such as Atlox 4862 (RTM) ex ICI, Daxad 15 (RTM) ex WR Grace, Galoryl LH16 (RTM) ex CFPI, lignosulphonic acid sodium salts such as Betz 402 (RTM) ex Betz, Lignosol NSX 110 (RTM), Maracell XE (RTM) and lignosulphonic acid calcium salts such as Lignosol FG (RTM) all ex Lignotech USA, Norlig A (RTM) ex Borregaard Lignotech and Lubrizol 5972 and 5994 both ex Lubrizol.

Viscosity modifiers may be present at a level from about 0.05 wt % to 5 wt % more preferably 0.08 to 3 wt %, based on the total weight of the composition.

2. Nonionic Emulsifiers

The fabric softening compositions may comprise one or more nonionic emulsifiers.

Especially preferred nonionic emulsifiers are alkoxylated (e.g. ethoxylated) C₁₀₋₂₂ fatty alcohols having a level of alkoxylation of 10 or more, more preferably 10 to 40, most preferably 11-25, e.g. 14-20.

Suitable nonionic emulsifiers include the Pluronics (RTM) range, ex BASF; the Tergitol (RTM) range, ex Union Carbide and the Genapol (RTM) range, ex Clariant. Examples include coco 20 ethoxylate and tallow 15 ethoxylate.

Nonionic emulsifiers may be present in the composition at a level of 0.1 to 20 wt %, more preferably 0.2 to 10 wt %, most preferably 0.3 to 5 wt %, based on the total weight of the composition.

3. Fatty Acids

The fabric softening compositions may comprise one or more fatty acids.

Preferred fatty acids are selected from the group consisting of C₈ to C₂₄ alkyl, alkenyl or hydroxyalkyl mono- or polymeric carboxylic acids.

Preferably the acids are saturated. Especially preferred acids are hardened tallow (C₁₆ to C₁₈) fatty acids.

Fatty acids may be present in the composition at a level of 0.1 to 15 wt %, more preferably 0.2 to 5 wt %, based on the total weight of the composition.

4. Water

The compositions are preferably aqueous. However, anhydrous compositions are also within the scope of the invention. If the product is anhydrous it is preferred that a low molecular weight hydroxylic solvent, such as isopropanol or pentanol, is present.

Water may be present in the composition at a level between 20 and 99 wt %, mo re preferably 25 to 97 wt %, e.g. 30 to 95 wt % based on the total weight of the composition.

5. Co-softeners

One or more co-softeners may be provided in the composition. Preferred co-softeners are fatty amines, fatty N-oxides, fatty esters and double chain cationic softeners.

Co-softeners may be present in an amount from 0.01 to 20% by weight, more preferably 0.05 to 10%, based on the total weight of the composition.

6. Perfumes

The compositions of the invention may also comprise one or more perfumes.

When present, the perfume is used in a concentration of from 0.01-15% by weight, more preferably from 0.05-10% by weight, most preferably from 0.1-5% by weight based on the total weight of the composition.

7. Other Optional Ingredients

The compositions may also contain one or more optional ingredients conventionally included in fabric conditioning compositions such as pH buffering agents, perfume carriers, fluorescers, colourants, hydrotropes, antifoaming agents, antiredeposition agents, polyelectrolytes, enzymes, optical brightening agents, anti-shrinking agents, anti-wrinkle agents, anti-spotting agents, germicides, fungicides, anti-corrosion agents, drape imparting agents, anti-static agents, ironing aids and dyes.

Composition Form

The softening compositions may be provided in any form known to those skilled in the art.

Preferred forms are solids, such as powders, pastes and gels, liquids or emulsions.

If the compositions are liquid, it is preferred that they have a viscosity that is acceptable to the consumer. Typically liquid compositions have a viscosity of 0.5 Pa.S (500 cps) or less, preferably 0.2 Pa.S (200 cps) or less, most preferably 0.18 Pa.S (180 cps) or less at a shear rate of 106s⁻¹ at 25° C., measured using a Haake rotoviscometer RV20.

Liquid compositions may be prepared as follows:

Method 1

An optional nonionic emulsifier is added to water or a hydroxylic solvent and dispersed. Then the CPED or RSED is added whilst the dispersion is stirred. This forms an emulsion which is ready for use as a softening composition.

Method 2

The CPED or RSED is warmed to 40° C. and water and the optional nonionic emulsifier are then added to the CPED or RSED under stirring to form an emulsion.

Method 3

The CPED or RSED is warmed to 40° C. and a low molecular weight hydroxylic solvent such as pentanol or isopropanol together with a nonionic emulsifier such as an ethoxylated nonionic compound is added to form an isotropic product.

In all of the above methods, other adjuncts, such as perfumes or fatty acids, may be added either together with the CPED/RSED or with the aqueous phase.

Product Form

It is particularly envisaged that the product will be a so-called rinse conditioner suitable for addition to an aqueous rinse liquor, the product comprising a carrier material for the softening compound such that the fabric softening compound will disperse in the rinse liquor upon addition of the product thereto. However, the carrier material could be a detergent composition, with the softening compound serving to give softening during the main wash cycle.

If the composition is to be used in the rinse cycle of a home textile laundering operation, it may be added directly in an undiluted state to the washing machine, e.g. through a dispenser drawer. Alternatively, it can be diluted prior to use.

When the rinse conditioners are dispersed in water, the solution preferably has a pH of from 1.5 to 7.

The compositions of the invention may also be used in a domestic hand-washing laundry operation.

The invention can also be utilised in compositions used on an industrial scale for finishing newly manufactured fabrics.

Alternatively, the compositions may be provided in a form suitable for use in a tumble dryer. For example, the composition may be impregnated into or coated onto a porous carrier article, which can then be inserted into a tumble dryer. The carrier article may be a flexible substrate which is capable of releasing the material in a tumble dryer. Such a product can be designed for single usage or for multiple uses and may be analogous to known products which use cationic fabric softening compounds. One such multi-use article comprises a porous sponge material releasably enclosing enough of the fabric softening material to impart fabric softness during several drying cycles. In use, the material melts and leaches out through the pores of the sponge to soften and condition fabrics. A single use sheet may comprise the fabric softening material carried on a flexible substrate such as a sheet of paper or woven or non-woven cloth substrate. When such an article is placed in an automatic laundry dryer, the heat, moisture, distribution forces and tumbling action of the dryer removes the composition from the substrate and deposits it onto the fabric. Substrate materials for single and multi-use articles, and methods of impregnating or coating them are described in U.S. Pat. No. 5,254,269 and elsewhere.

Without wishing to be bound by theory, it is believed that the compounds of the present invention are particularly suitable for use in tumble dryer based products because they have a lower melting point than conventional softeners, which are based on cationic softening compounds. Thus, at lower temperatures, they will deposit onto fabric more readily than conventional cationic fabric softeners.

Another possible application is in products for spraying directly onto fabric, for example when (or just before) ironing the fabric after it has been dried.

### EXAMPLES

The invention will now be illustrated by the following non-limiting examples.

The compositions were prepared as follows:

5 g of each of compounds 1 to 5 and N was heated to 75 C, either on its own or together with a nonionic emulsifier, Coco alcohol 20 EO (commercially available as Genapol C-200 (RTM), ex Clariant) to produce a mobile oil.

The oil was then added to water, optionally containing 2 g of a 25% solution of CTAC, cetyl trimethyl ammonium chloride, and the solution was heated to 75° C. A milky emulsion was formed containing 5 wt % of the softening compound. The emulsion was cooled to room temperature under stirring, and perfume was added. The emulsion was then stirred for a further 20 minutes at 800 r.p.m. under low shear (using a Heidolph RZR 2050 mixer).

The compositions are shown in Table 1. Compositions of the invention are denoted by a number whilst comparative comparisons are denoted by a letter.

TABLE 2

| | Composition | | | | | | |
|---|---|---|---|---|---|---|---|
| Component | 1 | 2 | 3 | 4 | 5 | A | B |
| Compound N | | | | | | 5 | 5 |
| Compound 1 | 5 | | | | | | |
| Compound 2 | | 5 | | | | | |
| Compound 3 | | | 5 | | | | |
| Compound 4 | | | | 5 | | | |
| Compound 5 | | | | | 5 | | |
| CTAC¹ | | | | | | 0.5 | |
| Perfume | 0.32 | 0.32 | 0.32 | 0.32 | 0.32 | 0.32 | 0.32 |
| Nonionic | | 0.75 | 0.75 | 0.75 | 0.75 | | 0.75 |
| Emulsifier² | | | | | | | |
| Water | To | To | To | To | To | To | To |
| | 100% | 100% | 100% | 100% | 100% | 100% | 100% |

¹cetyl trimethyl ammonium chloride, ex Aldrich
²Genapol C-200, ex Clariant.

All the amounts in table 2 are percentage by weight, based on the total weight of the composition.

The compositions were tested for their ability to deposit onto fabrics, to soften, for their perfume intensity once deposited onto fabrics and their effect on the absorbency of fabrics.

### Example 1

Deposition study

Each of the compositions 1 to 5, A and B was evaluated using colorimetric-transmittance for its ability to deposit onto cloth, as follows:

Demineralized water (1 liter) was added to a tergotometer (RTM) pot and stirred at 60 r.p.m. After 5 minutes, a first sample (3 ml), comprising water only, was removed. This sample was used for calibration of the calorimeter.

2 g of the fabric softening composition, 1 to 5, A or B, was added to the tergotometer pot and stirred at 60 r.p.m. for 5 minutes. Then, a second sample (3 ml) was taken. This sample was used for showing calorimetric transmittance when no deposition of the composition onto fabric had taken place.

Three pieces of terry towelling (20 cm×20 cm, 50 g total weight) were added to the tergotometer pot, and the contents were agitated for 5 minutes. A third sample (3 ml), which contained the fabric softening material not deposited on the fabric, was taken. This sample was used for showing the level of deposition of the composition onto fabric that had taken place.

The first sample was used to set the transmittance on a calorimeter to 100%. All measurements were made with a turbidity probe attached to a Brinkmann (trade name) PC 801 Colorimeter set at 520 nm. The transmittance of the second and third samples was then measured and compared to the transmittance of the first sample.

The transmittance value (given as a percentage) represents the degree of deposition. Higher transmission values (for the third sample) indicate greater deposition of the softening compound onto the fabric.

The results are shown in Table 3.

TABLE 3

| | | Transmittance | Transmittance |
|---|---|---|---|
| | Initial | prior to cloth | after cloth |
| | transmittance % | inclusion % | inclusion % |
| | (first sample) | (second sample) | (third sample) |
| Composition | | | |
| A | 100 | 20 | 88 |
| B | 100 | 26 | 31 |
| 1 | 100 | 23 | 100 |
| 2 | 100 | 84 | 86 |
| 3 | 100 | 60 | 98 |
| 4 | 100 | 29 | 74 |
| 5 | 100 | 36 | 80 |

The results show that the level of deposition of compositions of the invention onto fabric is much greater than the deposition of comparative composition B (unquaternized sucrose ester) and generally at least as good as the deposition of comparative composition A (unquaternized sucrose ester with CTAC deposition aid).

### Example 2

Softening Evaluation

Softening performance was evaluated as follows:

2 g of the fabric softening composition (5 wt % active dose dispersion for liquids) to tap water (1 liter), at room temperature in a tergotometer pot. Three pieces of terry towelling (20 cm×20 cm, 50 g total weight) were added to the tergotometer pot. The contents of the pot were agitated for five minutes at 65 r.p.m., spin dried to remove excess liquor, line dried overnight and conditioned at 21° C. in 65% relative humidity for 24 hours.

Softening of the fabrics was assessed by an expert panel of 10 people. Panel members were asked to assess each cloth on an 8 point scale, where 8=untreated harsh cloth and 1=very soft cloth. Softness scores were evaluated using an ‘Analysis of Variance’ technique. Lower values were indicative of better softening.

The softening results are given in Table 4.

TABLE 4

| Composition | Softening Score |
|---|---|
| A | 4.7 |
| B | 6.4 |
| 1 | 3.6 |
| 3 | 4.2 |
| 4 | 4.0 |
| 5 | 4.0 |

The results show that the compositions of the invention generally provide better softening results than comparative composition A and significantly better softening results than comparative composition B.

### Example 3

Perfume Performance

Perfume performance was evaluated by adding 2 g of the fabric softening composition (5% active dose dispersion for liquids) to tap water (1 liter), at room temperature in a tergotometer pot. Three pieces of terry towelling (20 cm×20 cm, 50 g total weight) were added to the tergotometer pot. The contents of the pot were then agitated for five minutes at 65 r.p.m., spin dried to remove excess liquor and line dried overnight for 24 hours.

Perfume intensity of the fabrics was assessed by an expert panel of 14 people. Panel members were asked to assess the perfume intensity for each cloth on an 5 point scale; ‘5’ denoted very strong intensity whilst ‘0’ denoted not detectable. Perfume scores were evaluated using an ‘Analysis of Variance’ technique. Higher values were indicative of greater perfume intensity.

The results are given in Table 5.

TABLE 5

| Composition | Perfume Intensity |
|---|---|
| B | 0.8 |
| 1 | 2.4 |
| 3 | 2.1 |

The results show that compositions of the invention provide a significantly greater perfume intensity to fabrics than the comparative composition.

### Example 4

Absorbency Evaluation

The effect of the compositions on the absorbency of fabrics was measured using the textile and paper industry wicking (Klemm) test. A strip of fabric (4 cm×30 cm) was placed in a tergotometer pot together with 2 g of the fabric softening composition (5% active dose dispersion for liquids) and tap water (1 liter), at room temperature. The contents of the pot were then agitated for five minutes at 65 r.p.m., spin dried to remove excess liquor and line dried overnight for 24 hours.

The treated strip of fabric was held vertically with a clip whilst the free end was weighed down with a piece of rubber. The strip was lowered into a tray containing 0.02% of a water soluble dye solution such that the rubber strip was just below the surface of the water. After 30 minutes, the wicking height (the height reached by the liquid moving up the strip) was measured.

For each composition, five fabric strips were tested and the average wicking height was calculated.

The results are given in Table 6.

TABLE 6

| Composition | Average Wicking Height, cm |
|---|---|
| 1 | 13.5 |
| 2 | 15.1 |
| 3 | 15.1 |
| 4 | 12.9 |
| 5 | 12.9 |
| Cationic fabric | 3.3 |
| softening composition¹ | |

¹Composition commercially available in UK (August 1999) containing 4.5 wt % di-hardened tallowoyloxy trimethyl ammonium propane chloride.

The results demonstrate that the fabrics treated with compositions of the invention remain significantly more absorbent than fabrics treated with a conventional cationic fabric softener.

Overall, the Examples show that compositions containing the compounds of the invention provide better softening results than compositions containing only conventional nonionic softening compounds and better fabric absorbency results than compositions containing conventional cationic softening compounds.

1. A compound comprising a derivative of a cyclic polyol or a derivative of a reduced saccharide having, on average, 30 to 80% of its hydroxyl groups esterified and/or etherified, the compound having one or more long chain C₈ to C₂₂ alkyl, alkenyl or hydroxyalkyl groups and one or more quaternary ammonium group, the C₈ to C₂₂ alkyl, alkenyl or hydroxyalkyl group(s) being attached to an ester or ether group.

2. A compound as claimed in claim 1 having, on average, 40% to 65% of the hydroxyl groups esterified and/or etherified.

3. A compound as claimed in claim 1 having two or more ester and/or ether groups.

4. A compound as claimed in claim 1 in which the compound is defined by formula (I):
(C₁₂O₃H₁₄)(OH)₈₋ₐ(OC(O)R¹N(R²)₃X)_{b}(OC(O)R³)_{c} (I)
where
R¹ is C₂₋₈ alkyl, alkenyl or hydroxyalkyl
R² is C₁₋₄ alkyl or hydroxyalkyl or C₂₋₄ alkenyl
R³ is C₈₋₂₂ alkyl, alkenyl or hydroxyalkyl
X is a water soluble anion
b=1 or more and preferably 2 or less
b+c is no more than 7
a=b+c,
or formula (II)
(C₆H₈O)(OH)₄₋ₐ(OC(O)R¹N(R²)₃X)_{b}(OC(O)R³)_{c} (II)
where
R¹, R², R³ and X are as defined above;
a=b+c
b=1 or more and preferably less than 2
b+c is no more than 3.

5. A compound as claimed in claim 1 where the iodine value of the parent fatty acid of the long chain C₈ to C₂₂ alkyl, alkenyl or hydroxyalkyl group is from about 40 to about 140.

6. A compound as claimed in claim 1 where the quaternary ammonium group is attached to the cyclic polyol or reduced saccharide via a short chain alkyl, alkenyl or hydroxyalkyl group.

7. A compound as claimed in claim 1 where the CPED is derived from sucrose.

8. A compound as claimed in claim 1 where the RSED is derived from sorbitan.

9. A fabric conditioning composition comprising 1 to 80 wt %, based on the total weight of the composition, of the compound defined in claim 1.

10. A method for forming a CPED or RSED comprising reacting a cyclic polyol or a reduced saccharide with a fatty acid and a halogen alkyl acid chloride to form an, at least partly, esterified cyclic polyol or reduced saccharide and then quaternising the, at least partly esterified and/or etherified compound so as to form a CPED or RSED comprising a quaternary ammonium group.
